(19) United States
(12) Patent Application Publication
(10) Pub. No.: US 2013/0154430 A1
(43) Pub. Date: Jun. 20, 2013

(54) INDUCTION ROTOR RETENTION STRUCTURE

(71) Applicants: Andrew Dragon, Fishers, IN (US); Balazs Palfai, Fishers, IN (US)

(72) Inventors: Andrew Dragon, Fishers, IN (US); Balazs Palfai, Fishers, IN (US)

(21) Appl. No.: 13/326,848

(22) Filed: Dec. 15, 2011

(51) Int. Cl. H02K 17/16; H02K 15/00

(52) U.S. Cl. 310/211; 29/596

(57) ABSTRACT

A shorting ring support structure of a rotor of an electric machine has a radially outer ring and a member extending radially inwardly from the outer ring and defining a radial length, the radially extending member being spaced axially inwardly from opposing axial surfaces of a die-cast shorting ring whereby the radially extending member is fully embedded in the shorting ring for a substantial majority of its radial length. Rotor conductor bars and the shorting ring are formed of an integrally cast material that secures the shorting ring support structure to the rotor body. A method of manufacturing includes providing a shorting ring support structure and a rotor body, and then casting conductor bars in slots of the rotor body and a shorting ring on the rotor body to form a rotor, where an outer ring of the support structure defines the outer radial limit of the shorting ring.

### BACKGROUND

The present invention relates generally to electric machines and, more particularly, to structure of and a method of making a die-cast induction rotor.

An induction motor is an asynchronous electric machine powered by alternating current (AC), where such power is induced in a rotor via electromagnetic induction. For example, polyphase AC currents may be provided to stator windings structured to create a rotating magnetic field that induces current in conductors of a rotor, whereby interaction between such induced currents and the magnetic fields causes the rotor to rotate. Induction motors may have any number of phases. An induction motor may operate as a generator, for example when driven at a negative slip.

Rotors of induction motors may conventionally include a cage such as a squirrel cage having axially parallel or skewed bars of copper or aluminum extending between opposite rotor ends and positioned at radially outward locations along the circumference of the rotor. Distal ends of individual bars may be provided with structural support and be in electrical communication with one another by connection of the respective bar ends to one or more continuous shorting ring disposed at each rotor end. The rotor may have a substantially cylindrical iron core formed as a stack of individual laminated disks of a silicon steel material. Each core disk may have slots or axial through holes for passing the copper or aluminum bars therethrough.

Due to the high costs associated with permanent magnet electric motors, electric machines for many different applications are being redesigned to utilize induction rotors. However, conventional die-cast induction rotors may have a reduced number of applications due to poor mechanical properties of the chosen die-cast material, especially when structural weakness is exacerbated by the size and speed of the rotor. When an induction motor is utilized in a given application such as automotive, the rotor must tolerate high speed rotation and associated large centrifugal force. In addition, high temperatures, potential metal fatigue, and other factors may aggregate with forces acting in a radial outward direction and those acting in an axial direction to cause structural breakdown resulting in damage or deformation of the cast shorting rings of a rotor. For example, an induction rotor generates higher temperatures within the rotor itself, further reducing mechanical and structural integrity of shorting rings.

### SUMMARY

It is desirable to obviate the above-mentioned disadvantages by providing a rotor for an induction motor, the rotor having a structure that enables a high speed operation in a high temperature ambient environment. The disclosed embodiments provide a method and structure for retaining the die-cast material of an induction rotor, specifically in shorting ring portions of the rotor. The disclosed embodiments also provide a method and structure that improve efficiency of an induction rotor, that minimize electrical losses in shorting ring portions of an induction rotor by maximizing the proportion of die-cast copper or other conductive material in the shorting ring portions, while still radially and axially retaining such die-cast material. The disclosed embodiments further provide a method and structure whereby die-cast shorting ring material is placed proximate a periphery of a shorting ring in specific locations chosen to optimize rotor performance, while still being radially and axially retained. By implementing such retention structure, the structural limitations of the die-cast material are greatly reduced.

According to an embodiment, an electric machine having a stator includes a rotor operably coupled with the stator, the rotor having a rotor body and defining a rotational axis. A plurality of conductor bars are supported on the rotor body and extend between axial ends of the rotor body. At least one shorting ring provides electrical communication between separate ones of the plurality of conductor bars. The electric machine includes at least one shorting ring support structure, the shorting ring support structure having a radially outer ring member and at least one member extending radially inwardly from the outer ring member and defining a radial length, the radially extending member being spaced axially inwardly from opposing axial surfaces of the shorting ring whereby the radially extending member is fully embedded in the shorting ring for a substantial majority of its radial length. The conductor bars and the at least one shorting ring are formed of an integrally cast material that secures the shorting ring support structure to the rotor body.

According to another embodiment, a method of manufacturing an electric machine having a stator includes providing a rotor body defining a rotational axis and having at least one slot extending between axial ends of the rotor body. The method includes providing a shorting ring support structure that includes an outer ring member having an axial end surface facing the rotor body, the axial end surface having a radially inner edge and a radially outer edge, the axial end surface being spaced apart from the rotor body at the radially inner edge and being engaged with the rotor body proximate the radially outer edge. The method also includes casting both at least one conductor bar in the slot and a shorting ring on the rotor body to thereby form a rotor wherein the outer ring member defines the outer radial limit of the shorting ring, whereby cast material secures the shorting ring support structure to the rotor body.

According to a further embodiment, a method of manufacturing an electric machine having a stator includes providing a rotor body defining a rotational axis and having a plurality of conductor slots extending between axial ends of the rotor body. The method includes providing first and second shorting ring support structures, each shorting ring support structure having an inner ring member, an outer ring member and a plurality of spokes radially extending between the inner and outer ring members. The method includes respectively positioning the first and second shorting ring support structures proximate opposite axial ends of the rotor body, and casting a plurality of conductor bars in corresponding ones of the plurality of conductor slots and casting first and second shorting rings at the opposite axial ends of the rotor body to thereby form a rotor, wherein the first and second shorting ring support structures define inner and outer radial limits of the first and second shorting rings respectively and wherein the spokes of each of the first and second shorting ring support structures are spaced axially inwardly from opposing axial surfaces of the first and second shorting rings whereby each of the spokes is fully embedded in one of the first and second shorting rings.

### BRIEF DESCRIPTION OF THE DRAWING FIGURES

The above mentioned and other features of this invention, and the manner of attaining them, will become more apparent and the invention will be better understood by reference to the following description of embodiments of the invention taken in conjunction with the accompanying drawing figures, wherein:

FIG. 1 is a schematic view of an electric machine;

FIG. 2 is a perspective view of an induction rotor lamination stack;

FIG. 3 is a top plan view of a retention structure for a rotor of an induction motor, according to an exemplary embodiment;

FIG. 4 is a perspective view of the retention structure of FIG. 3;

FIG. 5 is a cross section view taken along the line 5-5 of FIG. 3;

FIG. 6 is a perspective view of a retention structure mounted to an induction rotor lamination stack, according to an exemplary embodiment;

FIG. 7 is a perspective view of a die-cast material geometry that includes rotor bars and shorting rings of a rotor of an induction motor, according to an exemplary embodiment;

FIG. 8 is a perspective view of a rotor of an induction motor after a die-cast operation, according to an exemplary embodiment;

FIG. 9 is a cross-section view of a portion of the rotor of FIG. 8, taken along the line 9-9, with a hub portion being added for illustration purposes;

FIG. 10 is a perspective view of a completed rotor of an induction motor after hub assembly and O.D. machining, according to an exemplary embodiment;

FIG. 11 is a top plan view of a retention structure for a rotor of an induction motor, according to an exemplary embodiment; and

FIG. 12 is a cross section view taken along the line 12-12 of FIG. 11.

Corresponding reference characters indicate corresponding parts throughout the several views. Although the illustrated embodiments show several forms of the invention, such embodiments are exemplary and are not intended to be exhaustive or to be construed as limiting the scope of the invention to the precise forms or applications disclosed.

### DETAILED DESCRIPTION

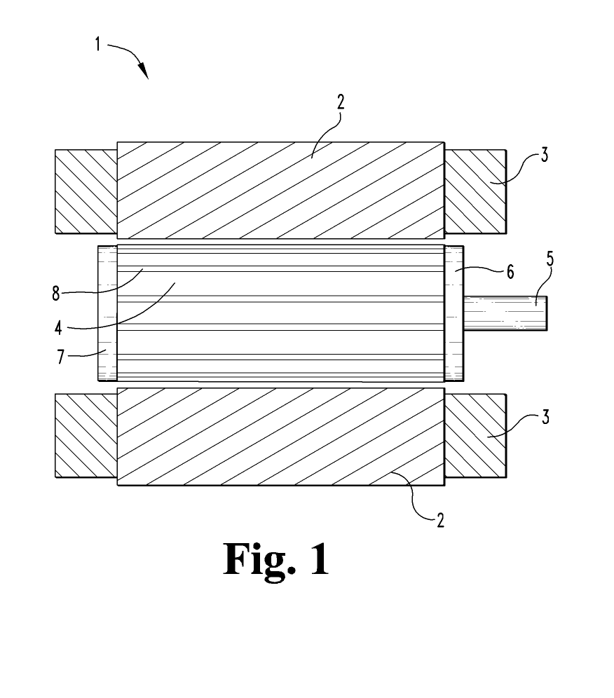

FIG. 1 is a schematic view of an electric machine 1 such as an induction motor/generator. In an exemplary embodiment, electric machine 1 may be a traction motor for a hybrid or electric type vehicle. Electric machine 1 has a stator 2 that includes a plurality of stator windings 3 typically disposed in an interior portion thereof. Stator 2 may be securely mounted in a housing (not shown) having a plurality of longitudinally extending fins formed to be spaced from one another on an external surface thereof for dissipating heat produced in the stator windings 3. For example, stator 2 may have a non-magnetic, electrically non-conductive bobbin (not shown) wound with separate phase coils. A rotor 4 has a center shaft 5 and is concentrically mounted within stator 2 so that rotor 4 rotates circumferentially respecting a longitudinal axis of shaft 5. Rotor 4 has a front shorting ring portion 6 and a rear shorting ring portion 7 respectively disposed at opposite axial ends of rotor 4, each being formed by a process that includes die-casting. When a voltage from an external power source (not shown) is supplied to the stator windings 3, stator 2 produces a rotating magnetic field. In operation, voltage is impressed on rotor 4 as an induced voltage. The inductive interaction of the rotating magnetic field with longitudinally extending conductive bars 8 of rotor 4 causes rotor 4 to rotate. Such conductor bars are formed along the outer circumference of rotor 4 and may be axial or skewed. The above-mentioned electric-kinetic energy flow is reversible because mechanical torque induced on rotor 4 will generate electricity.

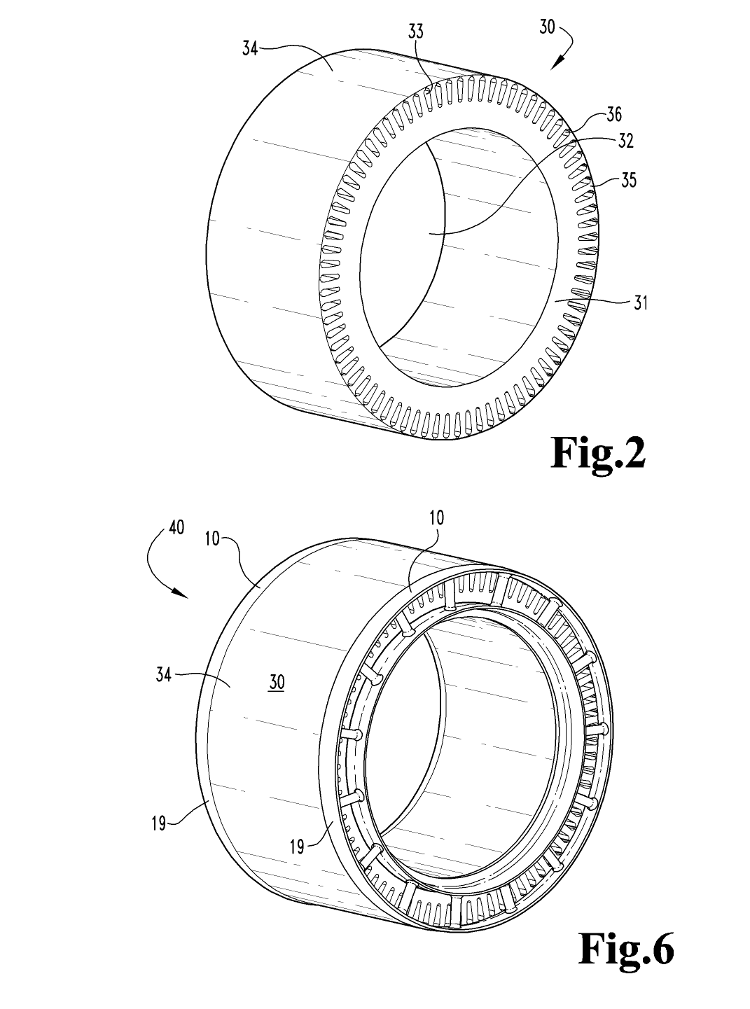

FIG. 2 shows an induction motor rotor lamination stack 30 formed by stacking individual laminations 31, for example silicone steel sheet metal in a general shape of a ring or disk. When assembled, lamination stack 30 has a generally columnar shape around a central longitudinal axis. Laminations 31 are typically formed of silicone steel material to minimize electromagnetic losses being generated in lamination stack 30 of rotor 4 during operation. Laminations 31 are each formed so that assembled lamination stack 30 has a uniform center aperture 32 where a shaft and associated structure may be positioned. Spaces 33 are formed around the periphery of each lamination 31, so that when laminations 31 are placed in registration with one another by forming lamination stack 30, such spaces form corresponding passages each extending in a generally lengthwise direction through lamination stack 30 proximate the radially outward exterior surface 34 of lamination stack 30. Laminations 31 may be formed, for example by a stamping operation, so that when a number of laminations 31 are stacked, the resultant passages are continuous. Such passages may be substantially parallel with the central longitudinal axis of rotor 4 or they may be skewed. An assembly of laminations 31 may be formed/stacked as a spiral. Variations in the thickness of laminations 31 may alter the rotation of the assembled rotor 4 and, therefore, it may be necessary to maintain tight mechanical tolerances for individual laminations 31, especially because a die-casting operation typically involves temperatures too high to allow laminations 31 to be bonded together with epoxy, or other suitable adhesive, prior to the die-casting. When exposed to such high temperature, many conventional epoxy materials will burn and out gas contaminants into adjacent materials.

In order to reduce vibration, magnetic noise, and unwanted linear and radial movement of laminations 31, and/or to reduce adverse effects of variations in dimensions (e.g., thicknesses) of individual laminations 31, lamination stack 30 may be formed with incremental variations in the shapes of individual laminations 31. In addition, for example, laminations 31 may be arranged in groups prior to stack assembly and such groups may include slight variations in shapes of individual teeth 35, whereby a particular resonance is avoided or a receptance distribution is altered. Lamination stack 30 may be formed with structure physically attached to individual laminations 31 or stack 30 in order to modify the corresponding electromagnetic profile. An assembly of lamination stack 30 may include bolting, riveting, welding, brazing, bonding, clamping, or staking, whereby mass distribution, elastic distribution, damping, and electromagnetic profile are affected. The electromagnetic structure may also be affected, for example, by selection of the particular interference fit used for staking adjacent laminations 31, and by the amount of force used by a staking punch for radially compressing a boss (not shown) of a lamination 31 within a hole of an adjacent lamination 31.

A die-casting operation, as discussed further below, involves copper, aluminum, or other electrically conductive casting material being poured or otherwise injected into a mold, whereby a cage such as a squirrel cage is formed to have rotor bars in the passages created by axial registration of spaces 33 of lamination stack 30, and is formed to have shorting rings electrically shorting the ends of the rotor bars together. Shorting rings at each longitudinal end of rotor 4 may be formed, generally, as plates or wheels that are coaxial with lamination stack 30.

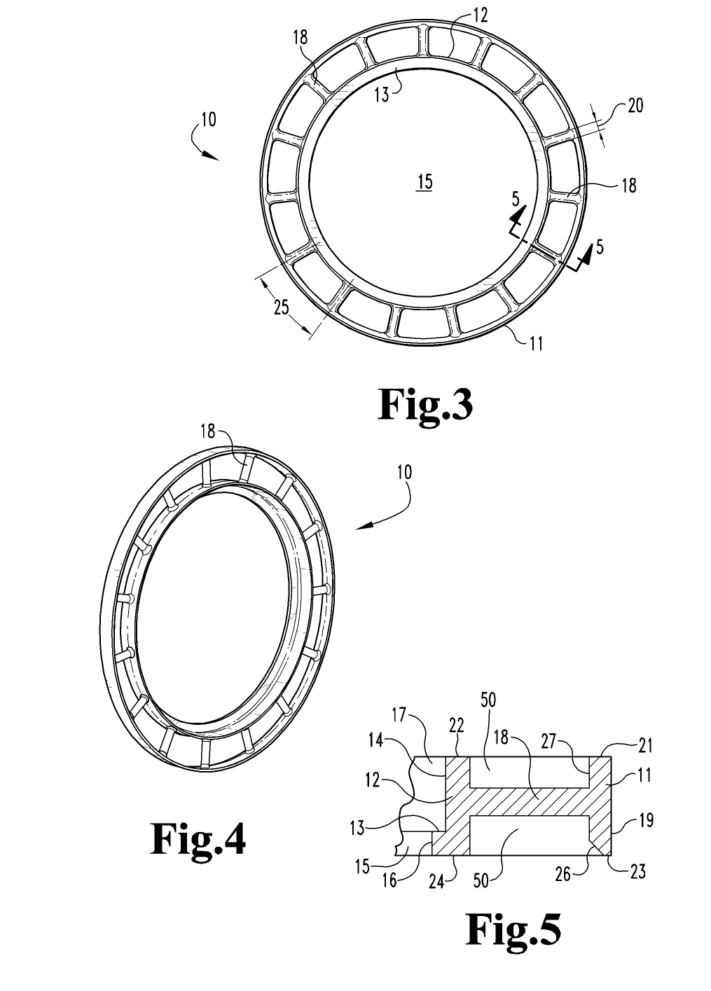

FIG. 3 and FIG. 4 show an exemplary shorting ring retention structure 10, and FIG. 5 shows a cross section taken along the line 5-5 of FIG. 3. Retention structure 10 may be formed of cast stainless steel, or other suitable material that is essentially non-magnetic to avoid generating losses in the shorting ring portion of rotor 4. Casting of shorting ring retention structure 10 allows implementation of various geometries not easily obtained by other processes such as stamping, though other methods such as fabrication or forging may be used to create the structure. In one embodiment, an outer ring 11 may have an outer diameter the same as or slightly less than an outer diameter of outer surface 34 of lamination stack 30. An inner ring 12 is concentric with outer ring 11 and may be formed with an annular flange portion 13 extending radially inward from an axially extending portion 14 of inner ring 12. A first annular interior space 15 is formed radially inward of an interior face 16 of flange portion 13. As shown in FIG. 5, a second annular interior space 17 is coextensive with first space 16 and has a radius larger by the width of flange 13 compared to the radius of first space 16. A plurality of radially extending spokes 18 connect inner ring 12 and outer ring 11. Spokes 18 may be formed to have cross section profiles that are round, square, rectangular, or in any other shape. Spokes 18 may be formed so that each spoke 18 is positioned axially inward of respective axially outward surfaces 21, 22 of outer ring 11 and inner ring 12, and is positioned axially outward of respective axially inward surfaces 23, 24 of outer ring 11 and inner ring 12. For example, spokes 18 may be positioned to be parallel with a plane that includes surfaces 23, 24 and may be positioned to bisect respective axially extending portions of inner and outer rings 12, 11. The thicknesses of outer ring 11 and inner ring 12 may cause either structure, by itself, to be insufficiently strong enough to maintain structural integrity of a die-cast end plate, but spokes 18 greatly improve the strength of outer ring 11 by their connection to inner ring 12. For example, spokes 18 retain outer and inner rings 11, 12 in their proper relative positions by being embedded within the cast material, thereby maintaining the proper position and integrity of retention structure 10 on rotor 4. As a result, outer ring 11 is able to withstand the hoop stresses caused by resistance to outward radial forces being imposed on outer ring 11, by virtue of its embedded spoked attachment to integrally formed inner ring 12. An annular chamfer 26 is formed between radially inward surface 27 and axially inward surface 23 of outer ring 11.

A pre-casting structure is shown in FIG. 6. Shorting ring retention structures 10 (see FIG. 5) each have essentially the same outside diameter as lamination stack 30, so that outer perimeter faces 19 are essentially flush with outer surface 34 of lamination stack 30. In an exemplary embodiment, a cylindrical mold, having an inner diameter equal to or slightly greater than the diameter of retention structure 10 and lamination stack 30, and having an essentially planar bottom surface that is orthogonal to the center axis of such cylinder, may be used for die-casting rotor 4. In such a case, a first shorting ring retention structure 10 is placed so that surfaces 21, 22 abut the bottom mold surface and outer perimeter face 19 of retention structure 10 fits snugly against the inner walls of the mold. Next, lamination stack 30 is placed so that the planar outer surface of the endmost lamination 31 is in abutment with surfaces 23, 24 of retention structure 10. The width or diameter 20 of each spoke 18 may be formed to be less than or equal to the widths of teeth 35 formed between each space 33 of lamination 3, whereby axially extending passages 36 are not covered when lamination stack 30 is placed onto retention structure 10. Lamination stack 30 and retention structure 10 may each have a keyed structure and/or angular locators (not shown), whereby spokes 18 are aligned with and overlie teeth 35. A second shorting ring retention structure 10 is then placed on top of lamination stack 30 and similarly aligned so that spokes 18 are atop respective ones of teeth 35. By such alignment, spokes 18 of the top retention structure 10 may also be circumferentially offset with respect to spokes 18 of the bottom retention structure 10, for example by being placed to bisect the arc 25 between adjacent spokes 18 of bottom retention structure 10. Typically, retention structures 10 may simply be aligned and held in place, although stakes may optionally be formed to align/secure retention structure 10 to an outermost lamination 31 at end(s) of lamination stack 30. After assembly, top and bottom retention structures 10 are in fluid communication with one another via the plurality of parallel passages 36. Passages 36 are typically not in communication with lamination stack outer surface 34. Pre-casting structure 40 may be formed so that no peripheral surface is exposed, whereby the die-cast material will remain within structure 40.

After the pre-casting structure 40 has been assembled, a beveled mandrel is inserted into the top retention structure 10, whereby annular center aperture 32 is completely covered. Similarly, any appropriate other areas and cavities are masked prior to die-casting. Any appropriate apparatus for tightening the assembly 40 may be employed, such as a use of opposed balance rings and fasteners, and various jigs known in the art, including one or more spacers and/or sleeve portions that may be inserted into first and/or second annular spaces 15, 17 and that may axially extend between top and bottom retention structures 10. Such sleeve portions may be chosen to snugly fit within laminate stack 30 and thereby align individual laminates 31 with one another, improving uniformity of annular center aperture 32. Sleeve portions may include guide pins, grooves, and the like. The mandrel may be tightened by a screwing apparatus or may transfer an external tightening and pressing force (e.g., hydraulic) to assembly 40. Similarly, a hub extension (not shown) may be utilized in a known stacking process that includes striking and thereby bending such extension with a tool. In various embodiments, a top retention structure 10 may have different structural shapes and features compared with a bottom retention structure 10, or they may be identical. The bottom surface of the mold may be separate and removable from a tubular mold portion and may be adjustable. The mold may include a double cylinder, such as for applying localized pressure.

The die-casting process typically includes melting aluminum at approximately 660-700° C., melting copper at approximately 1086-1100° C., or melting an appropriate electrically conductive alloy beyond its associated melting temperature. The molten metal is typically injected into the mold structure at a high flow rate and a high pressure. Assembly 40 may be gated at one end and vented at an opposite end, and the die-casting may utilize any number of air vents. When the bottom surface of the mold is horizontal, the cavity between outer ring 11 and inner ring 12 of bottom retention structure 10 fills with molten metal, each of the plurality of passages 36 then fill at essentially the same rate, and finally the cavity between outer ring 11 and inner ring 12 of top retention structure 10 fills. The mold may extend above surfaces 21, 22 of retention structure 10 (see, e.g., FIG. 5) so that the casting metal may be injected to completely cover surfaces 21, 22. The die-cast material may alternatively be injected to form a surface substantially coplanar with surfaces 21, 22, or it may be injected to form an outer surface that is axially inward of surfaces 21, 22. The mandrel is removed after the cast material has solidified.

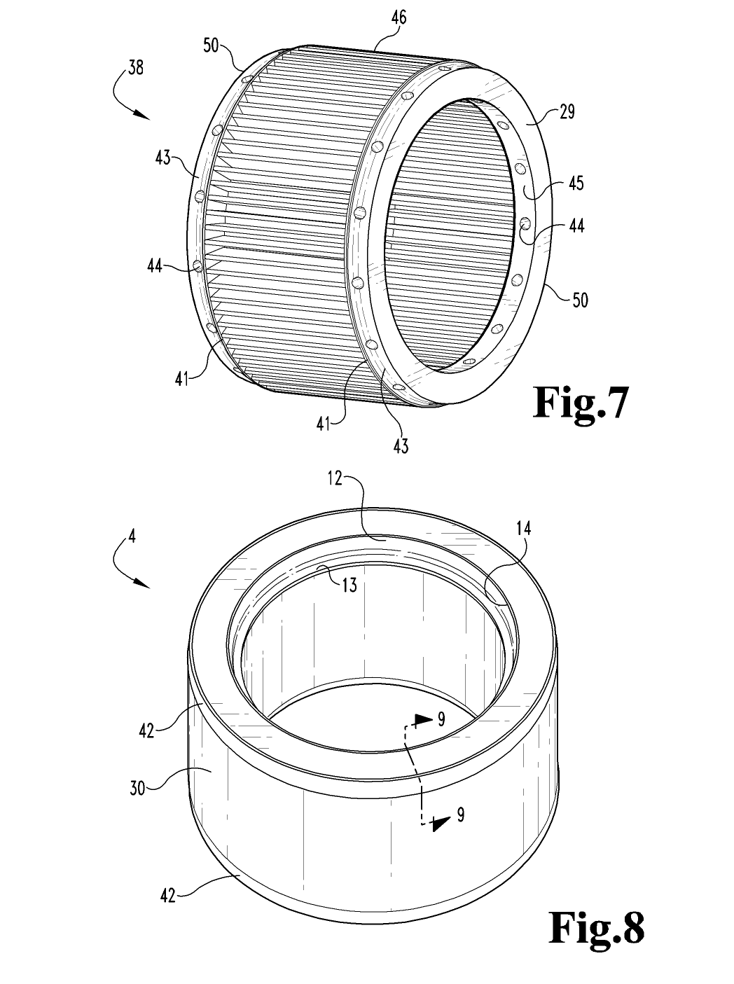

FIG. 7 shows an exemplary copper die-cast squirrel cage 38 having a plurality of axially extending conductor bars 46. The FIG. 7 view removes lamination stack 30 and retention structures 10 for purposes of illustration, and shows squirrel cage 38 prior to any post-casting machining. Distal ends of conductor bars 46 are electrically shorted together by opposed shorting rings 50. Such shorting rings 50 may have the same or different axial thicknesses. For example, shorting rings 50 may be dimensioned so that they produce the same dynamic stresses, even if such a requirement mandates different thicknesses. As discussed in the preceding paragraph, an axial end surface 29 of annular shorting ring portion 50 is typically formed during die-casting to be coplanar with surfaces 21, 22 of retention structure 10 so that additional machining of surface(s) 29 is not required after such die-casting. Chamfered portions 41 of respective shorting rings 50 extend outwardly from respective outer peripheral surfaces 43, whereby a larger volume of copper of the shorting ring 50 is in communication with conductor bars 46. Spoke volumes 44 extend radially outward from inner peripheral surface 45 to outer peripheral surface 43. The width or diameter 20 of each spoke 18, and corresponding diameter of each of respective spoke volumes 44, is typically formed to be as small as possible to maximize the current carrying capabilities and efficiency of shorting rings 50. As such diameters become smaller, resistance decreases in shorting ring portions where current flows around spokes 18 and the capacity of induced currents, and rotor efficiency, increases. Similarly, the number of spokes 18 may be minimized provided that the desired structural support, retention strength, and shorting ring durability are achieved. Spoke volumes 44 are offset with respect to opposite shorting rings 50 of rotor 4, so that electromagnetic resonance (e.g., high frequency noise) is avoided by reducing occurrences of asymmetric poles aligning with one another.

FIG. 8 shows rotor 4 after a die-casting process. Copper or other electrically conductive cast material is contained between a respective outer ring 11 and a respective inner ring 12 of each retention structure 10 (see, e.g., FIG. 5), and within passages 36 of lamination stack 30 (see, e.g., FIG. 2). The copper completely covers spokes 18 of retention structures 10 and forms respective axially outer surfaces 29 at distal ends of rotor 4. Surfaces 29 are typically the only exposed copper portions of rotor 4 after die-casting when subsequent machining of rotor 4 is specified.

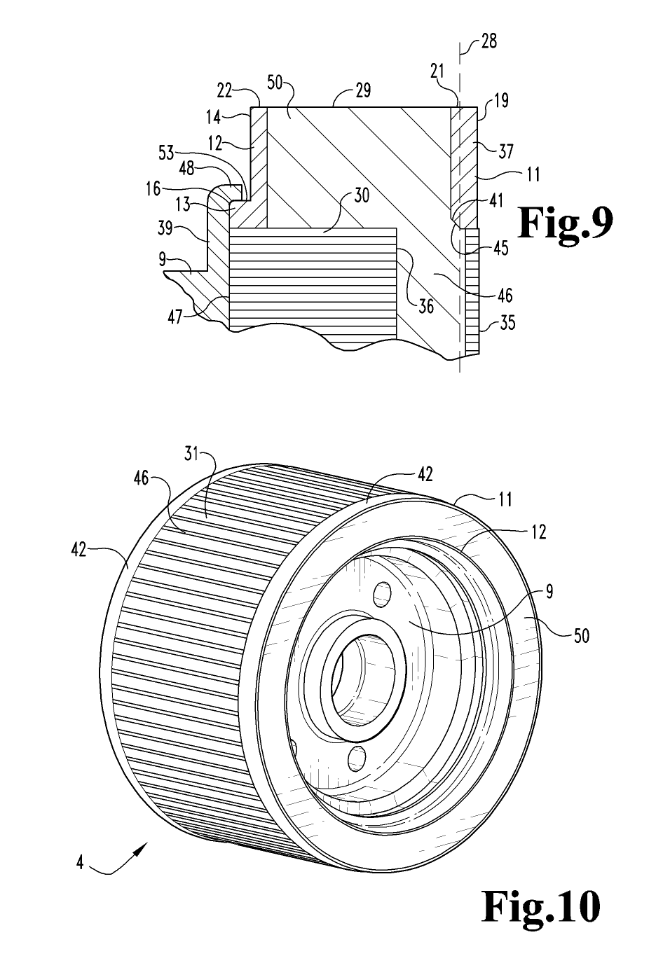

FIG. 9 shows a cross section of a representative portion of an exemplary rotor 4, taken along the line 9-9 of FIG. 8. For ease of description, the hub 9 of FIG. 10 is also shown in FIG. 9. Hub 9 is typically formed of steel having appropriate strength to transfer torque and may also include bearings and other structure for accepting a drive shaft 5. Hub 9 or portions thereof may be inserted into center aperture 32 either before or after die-casting. For example, hub 9 may be inserted into lamination stack 30 after the mandrel used in the die-casting process is removed, prior to machining. Hub 9 may be staked to inner ring 12 of retention structure 10. For such staking, hub 9 has an axially extending portion 39 that snugly fits in abutment with the annular interior 47 of lamination stack 30 and with radially inward surface 16 of inner ring 12. The axially outward end portion of axially extending portion 39 is bent radially outward and then axially inward so that an annular bent holding portion 48 of hub 9 is in abutment with an axially outward face 53 of flange 13. Annular holding portion 48 of hub 9 secures inner ring 12 and to prevent axial movement of retention structure 10. Inner ring 12 may optionally be formed to have more than one flange, for example having stepped annular portions, and spacers may be installed between hub 9 and inner ring 12. Flanges of inner ring 12 may be formed as a series of composite steps that allow laminate stack 30 to be accurately positioned onto hub 9. Flange 13 may optionally be staked with hub 9.

A shorting ring portion 50 is die-cast to be integral with conductor bars 46. Retention structure 10 is axially supported by the die-cast copper which is typically over-molded to completely enclose spokes 18. The essentially non-magnetic property of retention structure 10 prevents losses being generated in shorting ring 50. A chamfered annular edge 41 increases the efficiency of rotor 4 by including more of the die-cast copper in a shoulder region 45 between shorting ring portion 50 and integrally-formed die-cast copper conductor bars 46. The electrical current path through shoulder portion 45 thereby has a larger cross-sectional area and a higher current carrying capacity. Similarly, the spoke type wheel architecture of retention ring 10 allows outer ring 11 to be thinner because radial movement is restrained by spokes 18 and by inner ring 12. The thinner outer ring 11 also enables a larger volume of copper to be placed near the periphery of shorting ring 40 where distal ends of conductor bars 46 terminate, which further increases rotor efficiency. In addition, the radially outermost portion of rotor 4 may be machined to still further reduce the thickness of outer ring 11. Thickness of shorting ring 50, and corresponding axial lengths of inner and outer rings 11, 12 typically depend on desired motor size and speed.

Such machining may remove portions of rotor 4 that are radially outward of outside diameter (O.D.) machining line 28. The O.D. machining removes substantial portions of the teeth 35 of lamination stack 30, removes a radially outward portion 37 of outer ring(s) 11, and removes small radially outward portions of each of the conductor bars 46 so that conductor bars 46 are exposed along the exterior surface of rotor 4 as shown in FIG. 9. The O.D. machining typically removes radially outward portion 37 without removing chamfered edge 41 of outer ring 11, so that outer ring 11 is as thin as possible without exposing the copper of shoulder portion 45. In some cases, exposing a small circumferential stripe of the copper of shoulder 45 may not appreciably affect either motor 1 performance or durability of shorting ring 50. As a result of the O.D. machining, the diameters of respective peripheral surfaces 42 of outer rings 11 of retention structures 10 are made to be the same as the outside diameter of lamination stack 30, for example 180 mm. After the die-casting, the only exposed copper is typically at end surface(s) 29, and the O.D. machining typically further exposes only conductor bars 46. By comparison, an induction rotor having exposed but structurally supported shorting rings is disclosed, for example, in co-pending U.S. application Ser. No. ______, entitled, “Induction Rotor Shorting Ring Support Device,” incorporated herein by reference in its entirety. By maximizing copper mass of shorting rings 50 in proximity to conductor bars 46 while still preventing axial and radial movement/deformation of die-cast shorting rings 50, the current conduction path is maximized, and rotor efficiency and structural integrity are increased. As a result, rotor 4 of electric machine 1 is able to operate at higher rotational speeds. Respective radial thicknesses of inner and outer rings 12, 11 may be the same or different. For example, outer ring 11, after machining, may be thicker to withstand greater centrifugal force, although this will depend on the number of spokes 18 being used. Typically retention structure 10 is balanced so that hoop stress, stress concentration, and tension forces are balanced. For example, when a given portion of retention structure 10 has a significantly lower stress relative to other portions, the corresponding mass of material in the respective stress volume may be reduced. By reducing mass, the inertia of rotor 4 is reduced and rotor 4 is able to speed up or slow down more easily.

Retention structure 10 in combination with lamination stack 30 acts as an ersatz single-use casting tool/mold in that die-casting a traditional shorting ring requires tooling for defining radially inward and outward surfaces and one or more surfaces for mating with a hub, whereas the disclosed embodiments eliminate such tooling and associated costs. By use of the retention structure, the structural significance of the die-cast material is greatly reduced.

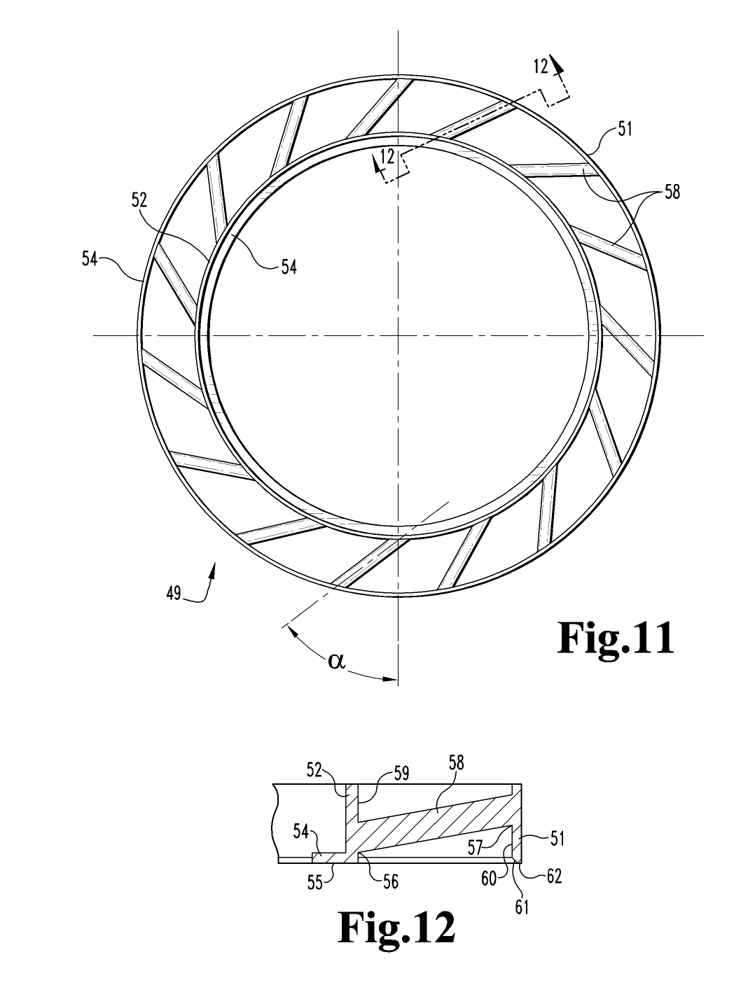

FIG. 11 shows another embodiment of an exemplary shorting ring retention structure 49, and FIG. 12 shows a cross section taken along the line 12-12 of FIG. 11. Retention structure 49 may be formed of a same material and in the same manner as retention structure 10, except that spokes 58 are arranged in a semi-tangent pattern, where spokes extend outward from an inner ring 52 at a chosen angle α away from the radii of inner ring 51 and outer ring 52. The higher the value of angle α, the more spoke 58 becomes tangential to inner ring 52. In the exemplary embodiment, spokes 58 may be formed to extend from any axial position 56 along the radially outward surface 59 of inner ring 52 to any axial position 57 along the radially inward surface 60 of outer ring 51. In a given embodiment, spokes of at least one of first and second shorting ring retention structures 49 may respectively extend in a direction which is non-perpendicular to the rotational axis. Retention structure 49 has an annular flange 54 extending radially inward from an axially inward portion of inner ring 52. Although flange portion 54 is shown by example as extending radially inwardly from an axial inward surface 55 of inner ring 52, flange portion 54 may alternatively be offset from surface 55 in the axially outward direction. Flange 54 provides an annular surface for receiving bent holding portion 48 of hub 9. Typically, outer ring 51 may have an outer diameter the same as or slightly less than an outer diameter of outer surface 34 of lamination stack 30, and inner ring 52 is concentric with outer ring 51. Similarly, the inner diameter of flange 54 is typically the same as the diameter of center aperture 32 of lamination stack 30. An annular chamfer 61 is formed between radially inward surface 60 and axially inward surface 62 of outer ring 51.

Retention structure 49 may be placed at each axial end of lamination stack 30 prior to die-casting. After a die-casting process, copper or other electrically conductive cast material is contained between outer ring 51 and inner ring 52 of each retention structure 49, and within passages 36 of lamination stack 30. Typically, the copper completely covers spokes 58 and distal axial ends of rotor 4 are the only exposed copper portions of rotor 4. Subsequent O.D. machining of rotor 4 typically removes the radially outward portion of outer ring 51 until all or nearly all of surface 62 is removed.

While various embodiments have been described in detail, further modifications and adaptations of the invention may occur to those skilled in the art. However, it is to be expressly understood that such modifications and adaptations are within the spirit and scope of the present invention.

What is claimed is:

1. An electric machine having a stator and comprising:
a rotor operably coupled with the stator, the rotor having a rotor body and defining a rotational axis;
a plurality of conductor bars supported on the rotor body and extending between axial ends of the rotor body;
at least one shorting ring providing electrical communication between separate ones of the plurality of conductor bars; and
at least one shorting ring support structure, the shorting ring support structure having a radially outer ring member and at least one member extending radially inwardly from the outer ring member and defining a radial length, the radially extending member being spaced axially inwardly from opposing axial surfaces of the shorting ring whereby the radially extending member is fully embedded in the shorting ring for a substantial majority of its radial length;
wherein the conductor bars and the at least one shorting ring are formed of an integrally cast material that secures the shorting ring support structure to the rotor body.

2. The electric machine according to claim 1, wherein the at least one radially extending member comprises a plurality of members extending radially inwardly from the outer ring member, each of the radially extending members being spaced axially inwardly from opposing axial surfaces of the shorting ring whereby each of the radially extending members are fully embedded in the shorting ring for a substantial majority of the radial length of the radially extending members.

3. The electric machine according to claim 2, wherein the rotor body defines a plurality of radially extending teeth positioned between the plurality of conductor bars and wherein each of the radially extending members is aligned with and overlies a respective one of the plurality of teeth.

4. The electric machine according to claim 1, wherein the at least one shorting ring comprises a first shorting ring and a second shorting ring respectively disposed at opposite axial ends of the rotor and the at least one shorting ring support structure comprises a first shorting ring support structure and a second shorting ring support structure wherein respective radially extending members of the first and second shorting ring support structures are disposed at different angular positions relative to the rotational axis.

5. The electric machine according to claim 1, wherein the shorting ring support structure further includes an inner ring member wherein the at least one radially extending member comprises a plurality of spokes extending from the inner ring member to the outer ring member, and wherein the integrally cast material of the shorting ring is confined between the inner and outer ring members.

6. The electric machine according to claim 5, wherein the outer ring member has an axial end surface positioned proximate and facing the rotor body, the axial end surface having a radially inner edge and a radially outer edge, the axial end surface being axially spaced apart from the rotor body at the radially inner edge.

7. The electric machine according to claim 6, wherein the axial end surface is engaged with the rotor body at the radially outer edge.

8. The electric machine according to claim 5, wherein the rotor body defines a central bore and the electric machine further comprises a hub disposed in the central bore and engaging the inner ring member, the inner ring member being radially secured between a portion of the hub and the rotor body.

9. A method of manufacturing an electric machine having a stator, the method comprising:
providing a rotor body defining a rotational axis and having at least one slot extending between axial ends of the rotor body;
providing a shorting ring support structure that includes an outer ring member having an axial end surface facing the rotor body, the axial end surface having a radially inner edge and a radially outer edge, the axial end surface being spaced apart from the rotor body at the radially inner edge and being engaged with the rotor body proximate the radially outer edge; and
casting both at least one conductor bar in the slot and a shorting ring on the rotor body to thereby form a rotor wherein the outer ring member defines the outer radial limit of the shorting ring, whereby cast material secures the shorting ring support structure to the rotor body.

10. The method according to claim 9, further comprising machining the rotor to remove material from the radial exterior surface of the outer ring member.

11. The method according to claim 10, wherein the at least one slot in the rotor body is fully circumscribed by the rotor body in a plane perpendicular to the rotational axis prior to the step of casting the at least one conduct bar in the slot and the step of machining exposes an outer radial surface of the at least one conductor bar.

12. The method according to claim 9, wherein the shorting ring support structure further includes an inner ring member, and wherein the casting of the shorting ring requires only a planar surface engaging the inner and outer ring members to form a mold for the cast shorting ring.

13. The method according to claim 12, wherein the shorting ring support structure further includes a plurality of spokes extending from the inner ring member to the outer ring member, and wherein the casting fully embeds the spokes in cast material of the shorting ring.

14. The method according to claim 9, wherein the shorting ring support structure further includes an inner ring member and a plurality of spokes extending from the inner ring member to the outer ring member, and wherein the casting fully embeds the spokes in cast material of the shorting ring.

15. The method according to claim 9 wherein the axial end surface has an outer radial portion which lies in a plane substantially perpendicular to the rotational axis and an angled portion which extends from the outer radial portion to the radially inner edge and is most distant from the rotor body at the radially inner edge.

16. A method of manufacturing an electric machine having a stator, the method comprising:
providing a rotor body defining a rotational axis and having a plurality of conductor slots extending between axial ends of the rotor body;
providing first and second shorting ring support structures, each shorting ring support structure having an inner ring member, an outer ring member and a plurality of spokes radially extending between the inner and outer ring members;
respectively positioning the first and second shorting ring support structures proximate opposite axial ends of the rotor body; and
casting a plurality of conductor bars in corresponding ones of the plurality of conductor slots and casting first and second shorting rings at the opposite axial ends of the rotor body to thereby form a rotor wherein the first and second shorting ring support structures define inner and outer radial limits of the first and second shorting rings respectively and wherein the spokes of each of the first and second shorting ring support structures are spaced axially inwardly from opposing axial surfaces of the first and second shorting rings whereby each of the spokes is fully embedded in one of the first and second shorting rings.

17. The method according to claim 16, wherein the inner ring member of at least one of the first and second shorting ring support structures includes at least one annular surface extending radially inwardly and axially inwardly of the corresponding axial end of the rotor body.

18. The method according to claim 16, wherein the rotor body defines a plurality of radially extending teeth positioned between the plurality of conductor slots, the method further comprising positioning the first and second shorting ring support structures so that each of the axially extending members is aligned with and overlies one of the plurality of teeth.

19. The method according to claim 16, wherein the inner and outer ring members of each of the first and second shorting ring support structures abut the rotor body prior to the step of casting the first and second shorting rings and thereby define the inner and outer radial limits of the first and second shorting rings.

20. The method according to claim 16, wherein the rotor body has a central bore and the inner ring member of the first shorting ring support structure has an L-shaped cross section and is positioned with a first leg projecting axially and a second leg projecting radially inwardly and wherein the method further includes mounting a rotor hub on the rotor body by positioning the hub at least partially in the central bore of the rotor body and staking a projecting lip of the rotor hub into engagement with the second leg.
